(19) United States
(12) Patent Application Publication
(10) Pub. No.: US 2010/0100898 A1
(43) Pub. Date: Apr. 22, 2010

(54) METHOD AND APPARATUS FOR PERSONALIZED MULTI-USER CENTRALIZED CONTROL AND FILTERING OF IPTV CONTENT

(75) Inventors: Gerald W. Pfleging, Batavia, IL (US); George Paul Wilkin, Bolingbrook, IL (US)

Correspondence Address: FAY SHARPE/LUCENT, 1228 Euclid Avenue, 5th Floor, The Halle Building, Cleveland, OH, 44115-1843, US

(73) Assignee: LUCENT TECHNOLOGIES INC., Murray Hill, NJ (US)

(21) Appl. No.: 12/252,650

(22) Filed: Oct. 16, 2008

(51) Int. Cl. H04N 7/16

(52) U.S. Cl. 725/28

(57) ABSTRACT

A method that allows subscribed content to be available to all users of an account on all devices that are capable of carrying the content. An administrator may tap into the features of the centralized data store to assign personalized usage guidelines and restrictions for all IPTV services available. This includes all devices and users within an administrator's account (including spouse, children, employees. etc.) Thus, an administrator may configure all devices under their control from a convenient centralized location without the need to locally configure each device or user profile. The administrator may enable access controls on the devices in their profiles (or subordinate profiles) from a Web-based system (that is also access controlled). The Web-based system allows the administrator to set content access controls that pertain to any or all devices (such as content blocking˜no “adult” material on any device at any time). The invention also allows the administrator to select filtering based on individual IDs (username, pins) or by device (child's cell phone, playroom DVR unit). The invention allows for content, channel, time, and other types of filtering for each ID or device.

### BACKGROUND OF THE INVENTION

This invention relates to a method and apparatus for centralized control and authentication in an IPTV system for the purpose of content filtering and control. While the invention is particularly directed to the art of telecommunications, and will be thus described with specific reference thereto, it will be appreciated that the invention may have usefulness in other fields and applications.

By way of background, entertainment content delivery to the home and to mobile devices has continued to climb as individuals continue to become more “connected” and request constantly new and updated news, sports, and entertainment content delivered to them when and where they want.

During the past few years devices such as DVR (Digital Video Recorder/Tivo®), PVR (Personal Video Recorder (computers)), Video iPod® and Mobile Cellular TV has given access to unprecedented content at any time that can be stored and later played back. The introduction of possibly thousands of channels of digital content through IPTV systems will only continue to feed the consumers desires for all content at all times.

IPTV (Internet Protocol Television) is a system in which digital television service is delivered by using Internet Protocol over a network infrastructure, which may include delivery by a broadband connection. A general definition of IPTV is television content that, instead of being delivered through traditional broadcast and cable formats, is received by the viewer through the technologies used for computer networks.

For residential users, IPTV is often provided in conjunction with Video on Demand and may be bundled with Internet services such as Web access and VoIP. In businesses, IPTV may be used to deliver television content over corporate LANs.

IPTV covers both live TV (multicasting) as well as stored video (Video on Demand VOD). The playback of IPTV generally requires either a personal computer or a set-top box connected to a TV. Video content is typically compressed using either a MPEG-2 or a MPEG-4 codec and then sent in an MPEG transport stream delivered via IP Multicast in case of live TV or via IP Unicast in case of Video on Demand. IP Multicast is a method in which information can be sent to multiple computers at the same time.

There is a growing standardization effort on the use of the 3GPP IP Multimedia Subsystem (IMS) for supporting IPTV services in carrier networks. Both ITU-T and ETSI are working on so-called “IMS-based IPTV” standards (see, e.g., ETSI TS 182 027).

The introduction of the new wireless and IPTV technology does, however, have a downside. The volume of content available can become overwhelming, with content that is available at all times either live or in a stored capacity that may not be suitable for all the individuals with access to the delivery/storage systems. Attempts have been made to help the users of these devices by implementing filtering controls on the playback of the storage units themselves using passwords or through the use of custom channel lists on each individual device.

These currently available methods are only somewhat effective in accomplishing their goals. They leave much to be desired and will become even more deficient as IPTV becomes more available and more content is available on more devices. Most of the currently implemented systems demand that the end user set up locking controls locally on each device or may provide the ability to use a web interface for each device.

Thus, there is a need for a method of managing the features and user services available as a centralized application within an IMS network. Such improvements will provide a more robust centralized system that can be adapted for use in a multi-user environment and will support flexible security and access requirements to all available users.

### SUMMARY OF THE INVENTION

A method and apparatus for centralized control and authentication in an IPTV system for the purpose of content filtering and control are provided.

In one aspect of the invention a method is provided. The method comprises: storing IPTV access and content filtering data for a plurality of IPTV users and IPTV devices in a database; receiving a request for an IPTV session from an authenticated IPTV user using an IPTV device; retrieving IPTV access and content filtering data for the IPTV user and the IPTV device from the database; and providing an IPTV content list for the IPTV user based on the IPTV filtering data for the IPTV user and the IPTV device.

In another aspect of the invention, an apparatus is provided. The apparatus comprises: a database for storing IPTV access and content filtering data for a plurality of IPTV users and IPTV devices; and an application server operative to: receive a request for an IPTV session from an authenticated IPTV user using an IPTV device; retrieve IPTV access and content filtering data for the IPTV user and the IPTV device from the database; and provide an IPTV content list for the IPTV user based on the IPTV filtering data for the IPTV user and the IPTV device

In yet another aspect of the invention, a computer program product is provided. The product comprises: a computer-usable data carrier storing instructions that, when executed by a computer, cause the computer to perform a method comprising: storing IPTV access and content filtering data for a plurality of IPTV users and IPTV devices in a database; receiving a request for an IPTV session from an authenticated IPTV user using an IPTV device; retrieving IPTV access and content filtering data for the IPTV user and the IPTV device from the database; and providing an IPTV content list for the IPTV user based on the IPTV filtering data for the IPTV user and the IPTV device.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a diagram of an IPTV network architecture suitable for implementing aspects of the present invention;

FIG. 2 is a memory layout of data stored in the database for IPTV subscribers in accordance with aspects of the present invention;

FIG. 4 is a flowchart illustrating an exemplary embodiment of the invention;

FIG. 5 is a flowchart illustrating an alternative embodiment of the invention; and

FIG. 6 is a call flow in accordance with aspects of the present invention.

### DETAILED DESCRIPTION

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a flash drive or a hard drive) or optical (e.g., a DVD), and may be read only or random access. Similarly, the transmission medium may be twisted wire pairs, coaxial cable, optical fiber, or some other suitable transmission medium known to the art. The invention is not limited by these aspects of any given implementation.

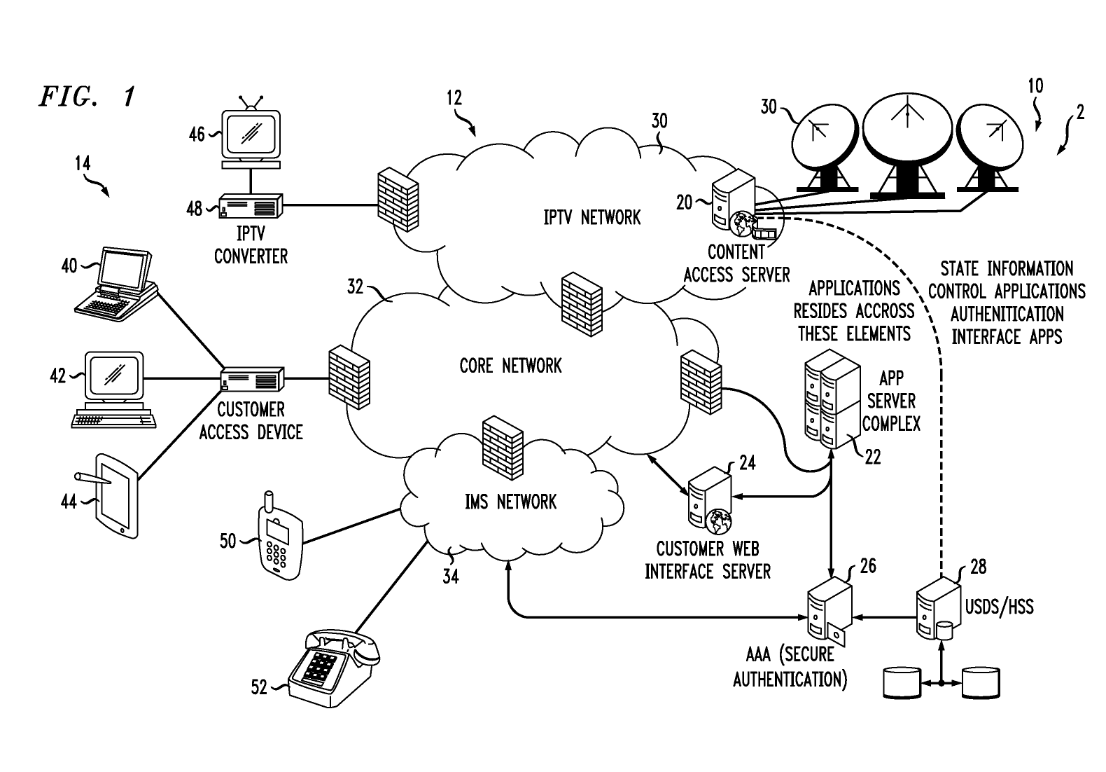

Referring now to the drawings wherein the showings are for purposes of illustrating the exemplary embodiments only and not for purposes of limiting the claimed subject matter, FIG. 1 provides a view of an IPTV network architecture 2 into which the presently described embodiments may be incorporated. As shown generally, the major functional components of the IPTV network architecture 2 include an IPTV service network 10, a communications network 12, and an IPTV user's home viewing network 14.

The IPTV service network 10 includes a number of network elements, including, but not limited to, a Content Access Server 20, an Application Server Complex 22, a Customer Web Interface Server 24, an AAA (Secure Authentication) Server 26, and a database 28.

The Content Access Server 20 receives IPTV streams from an IPTV content source 30 and broadcasts within the home viewing network 14 the IPTV streams associated with television broadcasts, pay-per view broadcasts, Internet video broadcasts, and the like. The maximum number of available IPTV streams is bounded by the Content Access Server 20 capabilities or the maximum bandwidth capabilities of the home viewing network 14.

The Content Access Server 20 generally includes a CPU (not shown) such as a microprocessor or a secure server and is in communication with the subscriber database 28 for storing pertinent information relating to the subscriber's IPTV service. The database 28 may be a Home Subscriber Server (HSS), a Unified Subscriber Data Server (USDS) or a special dedicated database for IPTV service. An HSS is a master user/subscriber database that supports the IMS network entities that actually handles calls. It contains the subscription-related information (user profiles), performs authentication and authorization of the user, and can provide information about the user's physical location. The USDS enables access to a subscriber's profile data in order to support key Home Location Register (HLR), Home Subscriber Service, and Authorization, Authentication and Accounting (AAA) requirements.

The AAA server 26 is a server program that handles user requests for access to computer resources and, for an enterprise, provides authentication, authorization, and accounting (AAA) services. The AAA server 26 typically interacts with network access and gateway servers and with databases and directories containing user information. The current standard by which devices or applications communicate with an AAA server is the Remote Authentication Dial-In User Service (RADIUS).

The communications network 12 includes a number of network elements, including, but not limited to, an IPTV Distribution Network 30, a Core Network 32, and an IMS Network 34.

The IPTV Distribution Network 30 provides the distribution capability, capacity, quality of service and other capabilities, such as multicast, necessary for the reliable and timely distribution of IPTV data streams from the Content Access Server 20 to the home viewing network 14.

The home viewing network 14 generally includes any number of end devices. FIG. 1 shows Web-based communication devices such as a notebook computer 40, a personal computer 42 and a personal digital assistant (PDA) 44, at least one IPTV viewing device 46, and any number of telephones (50, 52). Each IPTV viewing device 46 may have a corresponding IPTV converter or Set-Top Box (STB) 48.

The components of the home viewing network 14 may be arranged in any desired fashion. The Content Access Server 20 interfaces with the home viewing network 14 via the IPTV distribution network 30, which is typically a SIP-based system. SIP (or Session Initiation Protocol) is an application-layer control (signaling) protocol for creating, modifying, and terminating sessions with one or more participants. It can be used to create two-party, multiparty, or multicast sessions that include Internet telephone calls, multimedia distribution, and multimedia conferences. SIP is designed to be independent of the underlying transport layer; it can run on TCP, UDP, or SCTP. The latest version of the specification is RFC 3261 from the IETF SIP Working Group. It is widely used as a signaling protocol for Voice over IP, along with H.323 and others.

The home viewing network 14 may be wired, wireless, or a combination of wired and wireless. It is also noted that although the term “home” is used in connection with the phrase “home viewing network” that the network is not limited to a residential home or dwelling. That is, any local area network within a defined area viewing area accessible to a single account with an IPTV provider may be viewed as a home viewing network.

Customer delivery of IPTV is generally provided over the existing loop plant and the phone lines to homes using the higher-speed DSL technologies such as ADSL2+ and VDSL. Service providers may use a combination of Fiber-to-the Curb (FTTC) and DSL technologies or implement direct Fiber-to-the-Home (FTTH) access depending on the richness of their IPTV service offerings.

The IPTV viewing device 46 is generally a standard or high definition television or a monitor that permits video or television broadcasts to be viewed thereon. The IPTV converter 48 is the functional unit that terminates the IPTV traffic at the home viewing network 14. This device performs the functional processing, which includes setting up the connection and QoS (Quality of Service) with the Service Node, decoding the video streams, channel change functionality, user display control, and connections to user appliances such as a standard-definition TV or HDTV monitor. Each IPTV converter will be assigned with IMS Private and Public User IDs.

In some cases, the IPTV converter (Digital Versatile Recorder (DVR), etc.) 48 may be viewed as a remote viewing device, if that converter includes the processing instructions associated with directly interfacing with the distribution network 30. Moreover, each remote viewing device directly interfaces with a viewing device that is capable of presenting the IPTV streams of the home viewing network. Also, in some cases where the remote viewing device is not a converter, a remote viewing device may be directly interfaced with that converter.

The HSS 28 will generally treat each user's TV terminal as an IMS subscriber and store the corresponding IMS IDs and related service profiles. The HSS 18 may also stores Initial Filter Criteria (IFC) to contact the Content Access Server upon the end device's SIP REGISTER. The IFC may include ServiceInfo data that indicates the user has subscribed to the IPTV control and filtering service.

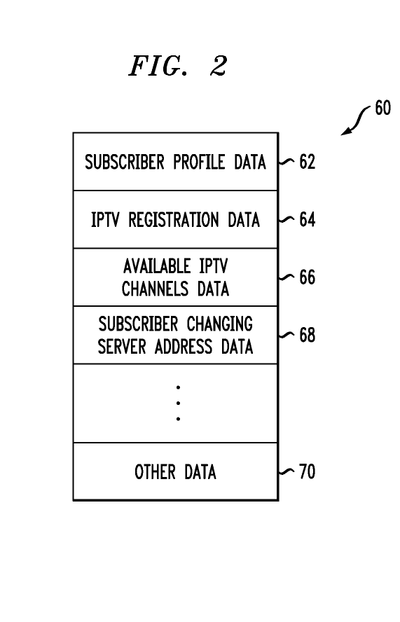

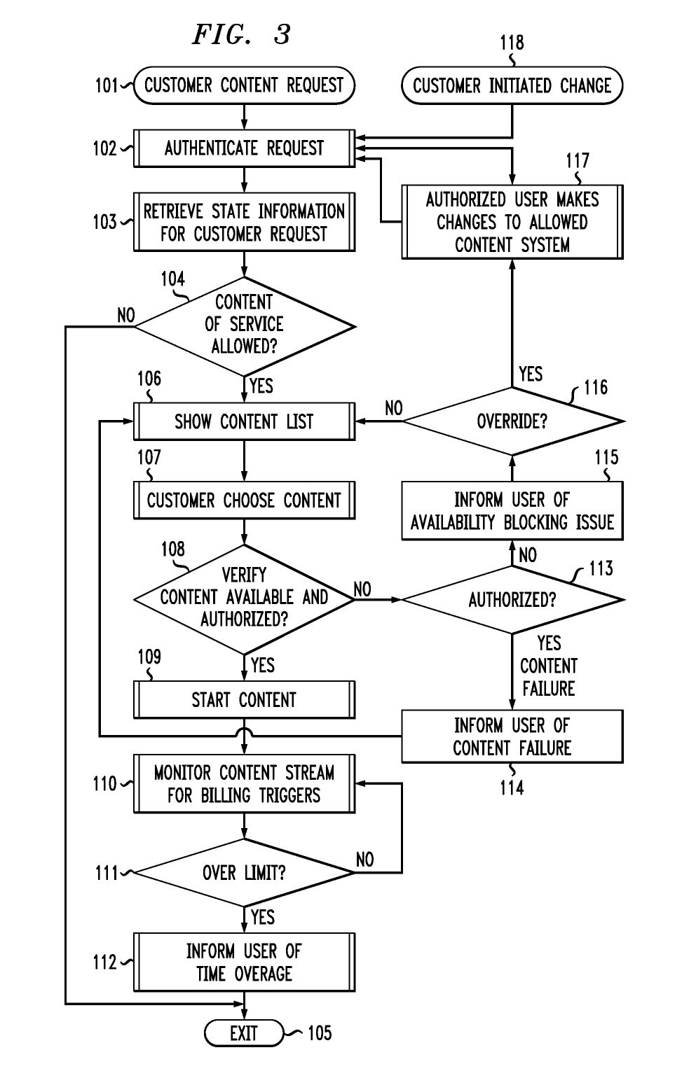

Thus, the HSS 28 generally includes any number of data sub-blocks for each administrator having IPTV service, as shown in FIG. 2. They are shown as a super block 60, not all of whose fields are filled for a particular subscriber. The super block 60, as known in the art, can be accessed from the identity of any one of several fields within it. The super block 60 includes any number of data sub-blocks, including a first sub-block 62 that contains subscriber profile data including Initial Filter Criteria data, a second sub-block 64 that contains IPTV registration data, a third sub-block 66 that contains available IPTV channels data (or level of service data) for users and devices, and a fourth sub-block 68 that contains subscriber charging server address data. Of course, any number of additional sub-blocks may be provided in the super block 60.

IMS networks promise to continue to drive convergence of user requested services such as wireline, wireless, and TV content delivery. One of the main advantages of implementing this converged system is the ability to aggregate a customer's data in one centrally controlled distributed system (SDHLR—Super Distributed Home Location Register) that can be accessed by any subsystem to gain provisioning, billing, personal and authentication data at any time.

The exemplary method allows subscribed content to be available to all users of an account on all devices that are capable of carrying the content. An administrator may tap into the features of the centralized data store to assign personalized usage guidelines and restrictions for all IPTV services available. This includes all devices and users within an administrator's account (including spouse, children, employees. etc.) Thus, an administrator may configure all devices under their control from a convenient centralized location without the need to locally configure each device or user profile.

The administrator may enable access controls on the devices in their profiles (or subordinate profiles) from a Web-based system (that is also access controlled). The Web-based system allows the administrator to set content access controls that pertain to any or all devices (such as content blocking—no “adult” material on any device at any time). The invention also allows the administrator to select filtering based on individual IDs (username, pins) or by device (child's cell phone, playroom DVR unit). The invention allows for content, channel, time, and other types of filtering for each ID or device.

Once the user controls are in place, when a device authenticates through the AAA service included in the IPTV/IMS system the new service is activated. That is, the MA Server 26 looks at the centralized user data storage (SDHLR) systems and matches the provided authentication information against what is contained in the online storage. If the credentials match and the content requested should not be filtered, then the content could be provided to the user on the requesting device. If the data presented does not allow the user to view the requested content, then messages to that affect may be delivered to the end user in the same manner as if the end-device does not subscribe to the requested content.

In order to better control what the end-user could see for channel, or even show, selections, the data that is provisioned into the central location could be pushed (or pulled) by the end device systems and stored in their memory (or storage systems). Such data may then be used when the user is attempting to use the on system guides to access content or access content that may be stored on the device that may be valid for others subscribing to view, but not the requesting viewer.

Yet one more convenience that may be provided by this service would be the ability for the end-user to go beyond the scheduling of one recording on one device type services that are currently available.

With the introduction of this centralized control system a user could request that a show or series be recorded in the centralized interface. The system then chooses from the known subscribed devices the unit that may be the best fit to accept the recording instructions and place the content in recording instructions on that device (or network element). For example, a show with an ‘MA’ rating may be recorded and stored on a system in a parent's office or bedroom vs. a family room unit. Most current DVR units will require a password locally to set up a recording, but if the recording units attached TV is turned on during the recording, the content being recorded is available in the clear for any users to view.

An exemplary embodiment of the invention is illustrated in FIG. 3. Initially, a customer content request is received by the network 12 (101). For example, the viewing device 46 and IPTV converter 48 are turned on by a user. It is to be understood, however, that the user could be using any one of the other communication devices in the home viewing network 14 to view IPTV content. An authentication request is then made (102). Accordingly, the AAA Server 26 retrieves “state info” for the customer content request (103). Next, a determination is made as to whether the requested content or service is allowed for the user and/or device (104). If not, then the session is ended (105).

Otherwise, if the requested content or service is allowed, the content list is displayed on the viewing device 46 (106). In turn, the customer chooses content (107). Next, a determination is made as to whether the content is available and authorized (108). If so, then the content is started (109). In the meantime, the content stream is monitored for billing triggers (110). In turn, a determination is made as to whether a billing limit has been reached (111). The limits can be based on any combination of factors, including cost, total time, and time of day. If not, then the Application Server 22 continues to monitor the content stream for billing triggers. Otherwise, the user is informed of the limit overage (112), and the session is ended.

If, however, the content is not available and authorized, then a further determination is made as to whether the content is authorized (113). If so, then there has been a content failure and the user is informed via an audio or visual message through the viewing device 46 (114). The content list is shown again (106).

Otherwise, the user is informed of the blocking issue via an audio or visual message through the viewing device 46 (115). Next, a determination is made as to whether the user may override the content blocking (116). If not, then the limited content list is shown again (106), and the process repeats. Otherwise, the authorized user (e.g., the administrator) makes changes to allowed content system (117). At that point, the request is authenticated as before (102).

It should also be noted that a user may initiate a change service request through the Internet (118). The request is authenticated (102). If authenticated, the user may make changes to the allowed content system (117).

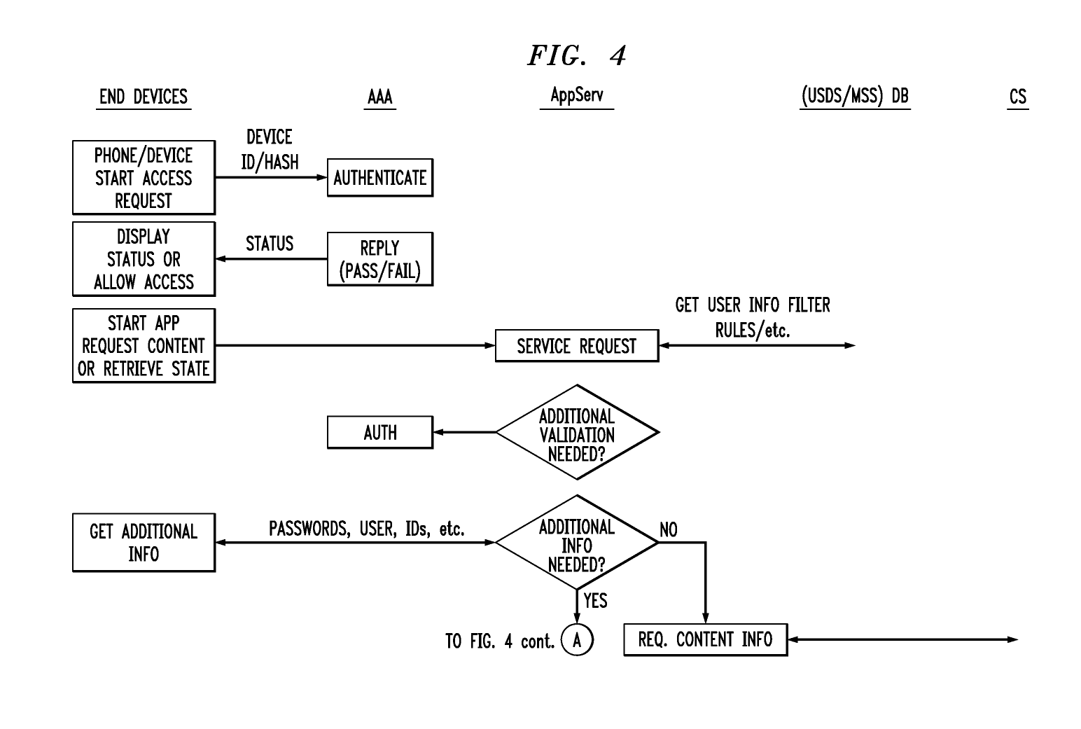

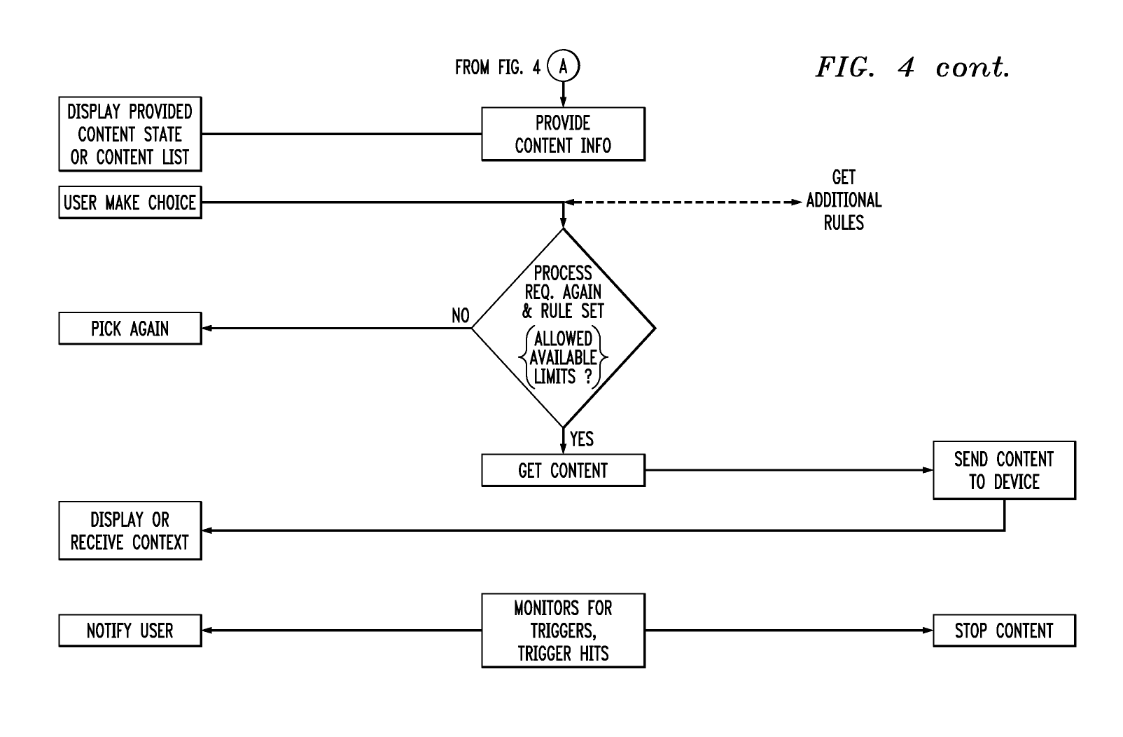

FIG. 4 relates to a call flow illustrating an exemplary embodiment of the invention. Initially, an access request is sent from any one of the end devices shown in FIG. 1 such as the mobile phone 50, the viewing device 46, etc. The end device ID/hash is sent to the AAA Server 26 for authentication. Upon authentication, the AAA Server 26 sends a reply to the end device. The reply is either pass or fail. In turn, the status is displayed on the end device or access is allowed. Next, the application is started (request content or retrieve state). The service request is received by the Application Server 22, which communicates with the database 28 to retrieve user info, filter rules, etc. The Application Server 22 determines whether additional validation is needed by sending a message to the AAA Server 26. Also, the Application Server 22 determines whether additional information is needed. If so, then additional pass codes, user IDs, etc. are obtained from the user through the end device. If not, a message is sent to the Content Access Server 20 requesting content info. The content info is sent from the Application Server 22 to the end device, which displays the provided content, state, or content list. The user makes a choice and this is sent to the Application Server 22, which processes the request against the rules set. That is, the Application Server 22 communicates with the database 28 in order to obtain any additional rules, such as program content limitations, programs available, time limits, etc. If the choice is not within the rules set, then the message is sent to the end device instructing the user to pick again. However, if the choice is allowed and available, then the Application Server 22 sends a message to the Content Access Server 20 to send the content to the end device. In turn, the content is displayed on the end device. In the meantime, the Application Server 22 monitors for triggers. If there is a hit, then the content is stopped.

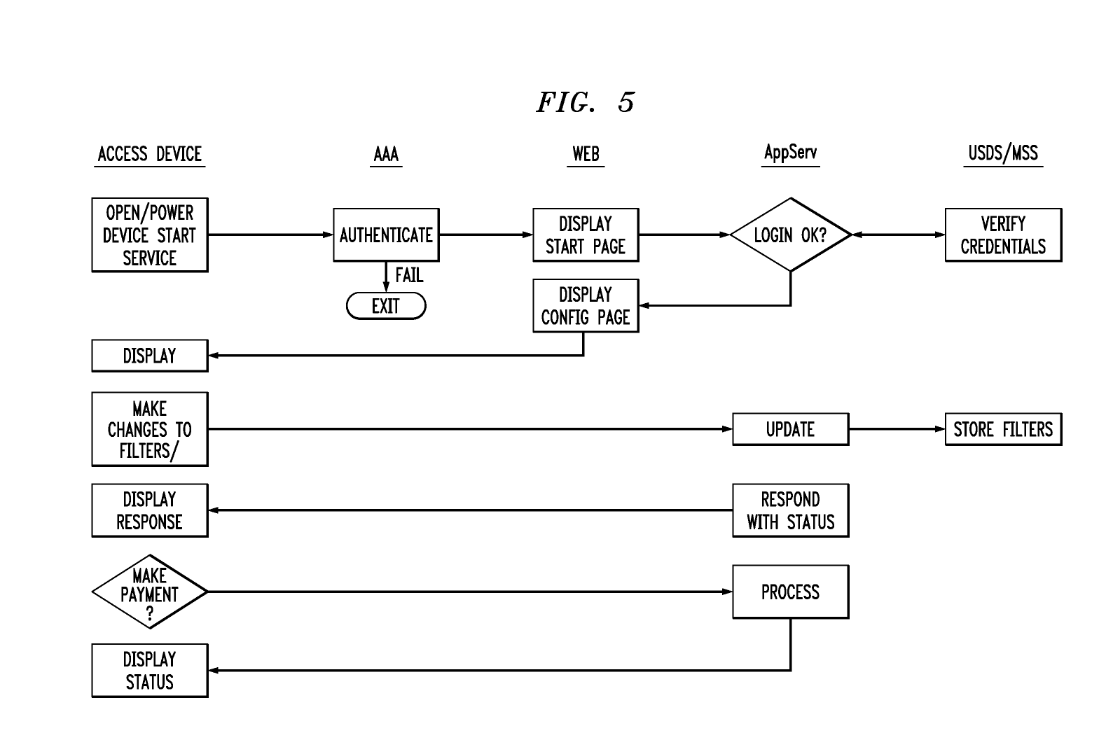

FIG. 5 is an additional call flow regarding the content administration procedure. Initially, any one of the access devices shown in FIG. 1, such as the mobile phone 50, is powered up. Authentication is made at the AAA Server 26. If there is an authentication failure for the access device or the user, then the communication is ended. Otherwise, a message is sent to the Customer Web Interface Server 24 with instructions to display a start page. The Application Server 22 then receives request as to whether the log in is approved. The Application Server 22 verifies the credentials of the database 28. The Application Server 22 then returns a message to the Customer Web Interface Server 24 to display the configuration page. The Customer Web Interface Server 24 then sends a message to the access device to display the appropriate web pages. The user makes the changes to the appropriate filters via the access device and the Application Server 22 updates the information stored in the database 28. The Application Server 22 responds with the status, and the response is displayed on the access device. The user may make a payment via the access device and web interface, which is processed by the Application Server 22. Finally, the Application Server 22 sends a message regarding the payment status to the access device, which displays the status for the user.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A method comprising:
storing IPTV access and content filtering data for a plurality of IPTV users and IPTV devices in a database;
receiving a request for an IPTV session from an authenticated IPTV user using an IPTV device;
retrieving IPTV access and content filtering data for the IPTV user and the IPTV device from the database; and
providing an IPTV content list for the IPTV user based on the IPTV filtering data for the IPTV user and the IPTV device.

2. The method of claim 1, wherein the IPTV access and content filtering data comprises content access controls for one or more IPTV devices and content filtering controls based on at least one of content, channel, and time.

3. The method of claim 1, further comprising:
receiving an IPTV content selection from the IPTV user based on the IPTV content list; and
instructing an IPTV content server to start an IPTV content stream for the IPTV user based on the IPTV content selection.

4. The method of claim 3, further comprising:
monitoring the IPTV content stream for at least one of a plurality of billing triggers; and
informing the IPTV user of a limit overage.

5. The method of claim 4, wherein the billing triggers comprise cost, total time, and time of day.

6. The method of claim 1, further comprising:
receiving an IPTV content selection from the IPTV user based on the IPTV content list; and
verifying whether the IPTV content selection is available and authorized.

7. The method of claim 6, further comprising:
informing the IPTV user that the IPTV content selection is available but the IPTV device is blocked;
determining whether the IPTV user is authorized to override the block; and
permitting an authorized user to override the block.

8. An apparatus comprising:
a database for storing IPTV access and content filtering data for a plurality of IPTV users and IPTV devices; and
an application server operative to:
receive a request for an IPTV session from an authenticated IPTV user using an IPTV device;
retrieve IPTV access and content filtering data for the IPTV user and the IPTV device from the database; and
provide an IPTV content list for the IPTV user based on the IPTV filtering data for the IPTV user and the IPTV device.

9. The apparatus of claim 8, wherein the IPTV access and content filtering data comprises content access controls for one or more IPTV devices and content filtering controls based on at least one of content, channel, and time.

10. The apparatus of claim 8, wherein the application server is further operative to:
receive an IPTV content selection from the IPTV user based on the IPTV content list; and
instruct an IPTV content server to start an IPTV content stream for the IPTV user based on the IPTV content selection.

11. The apparatus of claim 10, wherein the application server is further operative to:
monitor the IPTV content stream for at least one of a plurality of billing triggers; and
inform the IPTV user of a limit overage.

12. The apparatus of claim 11, wherein the billing triggers comprise cost, total time, and time of day.

13. The apparatus of claim 8, wherein the application server is further operative to:
receive an IPTV content selection from the IPTV user based on the IPTV content list; and
verify whether the IPTV content selection is available and authorized.

14. The apparatus of claim 13, wherein the application server is further operative to:
inform the IPTV user that the IPTV content selection is available but the IPTV device is blocked;
determine whether the IPTV user is authorized to override the block; and
permit an authorized user to override the block.

15. A computer program product comprising:
a computer-usable data carrier storing instructions that, when executed by a computer, cause the computer to perform a method comprising:
storing IPTV access and content filtering data for a plurality of IPTV users and IPTV devices in a database;
receiving a request for an IPTV session from an authenticated IPTV user using an IPTV device;
retrieving IPTV access and content filtering data for the IPTV user and the IPTV device from the database; and
providing an IPTV content list for the IPTV user based on the IPTV filtering data for the IPTV user and the IPTV device.

16. The computer program product of claim 15, wherein the IPTV access and content filtering data comprises content access controls for one or more IPTV devices and content filtering controls based on at least one of content, channel, and time.

17. The computer program product of claim 15, wherein the computer-usable data carrier stores instructions that, when executed by a computer, further cause the computer to further perform the following steps:
receiving an IPTV content selection from the IPTV user based on the IPTV content list; and
instructing an IPTV content server to start an IPTV content stream for the IPTV user based on the IPTV content selection.

18. The computer program product of claim 17, wherein the computer-usable data carrier stores instructions that, when executed by a computer, further cause the computer to further perform the following steps:
monitoring the IPTV content stream for at least one of a plurality of billing triggers; and
informing the IPTV user of a limit overage

19. The computer program product of claim 15, wherein the computer-usable data carrier stores instructions that, when executed by a computer, further cause the computer to further perform the following steps:
receiving an IPTV content selection from the IPTV user based on the IPTV content list; and
verifying whether the IPTV content selection is available and authorized.

20. The computer program product of claim 19, wherein the computer-usable data carrier stores instructions that, when executed by a computer, further cause the computer to further perform the following steps:
informing the IPTV user that the IPTV content selection is available but the IPTV device is blocked;
determining whether the IPTV user is authorized to override the block; and
permitting an authorized user to override the block.
